(19) United States
(12) Patent Application Publication
(10) Pub. No.: US 2002/0166056 A1
(43) Pub. Date: Nov. 7, 2002

(54) Hopscotch ticketing

(76) Inventors: William C. Johnson, Los Angeles, CA (US); Simon P. Simpson, Monrovia, CA (US)

Correspondence Address: FENWICK & WEST LLP, TWO PALO ALTO SQUARE, PALO ALTO, CA, 94306, US

(21) Appl. No.: 10/136,853

(22) Filed: Apr. 30, 2002

Related U.S. Application Data
(60) Provisional application No. 60/288,852, filed on May 4, 2001.

(51) Int. Cl. H04L 9/00

(52) U.S. Cl. 713/193; 713/182

(57) ABSTRACT

Hopscotch ticketing enforces restrictions on use of digital content without materially affecting an end-user's (116) ability to exploit the content. A content owner (110) encrypts digital content and distributes the encrypted content to distributors (114). The end-user (116) obtains the content from a distributor (114). The distributor (114) provides a service center (112) with a distributor identification (ID), an end-user ID, and a content ID. The service center (112) generates a key for the identified end-user (116) and provides the key and IDs to the content owner (110). The content owner (110) determines the key for the content, encrypts the key with multiple levels of encryption, and provides the content key to the service center. The service center (112) provides the content key (300) to the distributor (114), which removes one level of encryption and provides the content key to the end-user (116). The end-user (116) removes the remaining levels of encryption and uses the content key to access the content.

### CROSS-REFERENCE TO RELATED APPLICATIONS

This application claims the benefit of U.S. Provisional Application No. 60/288,852, filed May 4, 2001, which is hereby incorporated by reference in its entirety. This application is related to the following United States patents, which are hereby incorporated by reference in their entireties: U.S. Pat. Nos. 5,727,061; 5,694,472; 5,604,800; 5,692,049; 5,696,825; 5,610,980; 5,644,710; 5,689,564; 5,778,068; and 5,619,574.

### BACKGROUND

1. Field of the Inventions

This invention pertains in general to digital rights management and in particular to restricting access to secured digital content.

2. Background Art

Unauthorized duplication of digital content has become a substantial problem. Many forms of content, such as music, movies, software, and books, are distributed digitally. The content can be distributed via a number of different media, including computer networks, compact disks (CDs), DVDs, etc. Much of the content is distributed without any safeguards against unauthorized duplication, while certain content, such as DVD movies, is only nominally protected.

Even the protected content, however, can usually be duplicated without undue effort. The standard encryption formats for DVDs and electronic books have been compromised, thereby allowing unfettered access to the content. Moreover, several proposed schemes for protecting digital music have been found wanting.

As a result, piracy of digitally distributed content is a significant problem. Music copied from unprotected CDs is “ripped,” compressed, and distributed via the Internet. Moreover, perfect digital copies of the CDs can be “burned” for only a minimal cost. Recordable DVD players are becoming mainstream and there may soon be a resulting increase in DVD piracy. As a result of this piracy, the rights-holders associated with the content, such as the creators, publishers, etc., are often not receiving full compensation for the content.

Many solutions have been proposed in attempts to address the above-mentioned problems. However, these proposed solutions typically restrict the end-user's (i.e., the consumer of the content's) ability to perform tasks for which the end-user has a legal right and/or a legitimate expectation. For example, some proposed solutions introduce intentional errors into the CD media itself in an attempt to foil the hardware utilized to burn duplicate CDs. These proposed solutions, however, may cause playback devices to malfunction, degrade the quality of the digital content, and/or prohibit the end-user from making a legitimate copy of a CD.

Therefore, there is a need in the art for a way to secure digital content that cannot be easily defeated yet does not impede the end-user's ability to exploit the content for legitimate purposes. Preferably, the solution to this need will allow the rights-holders to ensure that they are compensated for appropriate uses of the content.

### DISCLOSURE OF INVENTION

The above need is met by a hopscotch ticketing system (100) that enforces thresholding encryption of digital content, but allows legitimate end-users to decrypt and exploit the content. An embodiment of the system includes a content owner (110), a service center (112), and a distributor (114). The content owner (110) is representative of the M parties that have rights in the content. The M parties preferably encrypt the content using a thresholding encryption scheme. The content is distributed, in encrypted form, to the distributor (114). The distributor (114) makes the encrypted content available to end-users (116).

Each end-user (116) seeking to access the content preferably anonymously registers a device with the service center (112). During registration, the service center (112) and end-user (116) (i.e., the device) establish shared data. The shared data may be established by exchanging data or cross-referencing preexisting data stored by the device (and inaccessible to the human user) and the service center (112). Similarly, each distributor (114) preferably registers and establishes shared data with the content owner (110) or another entity acting on the content owner's behalf. These shared data create parallel relationships between the distributor (114) and content owner (110) and user (116) and service center (112). Due to these relationships, a message from the content owner (110) to the distributor (114) can pass through, but effectively “skip over,” the service center (112) because the message cannot be decrypted by the service center. Likewise, a message from the service center (112) to the end-user (116) can skip over the distributor (114). For this reason, the system (100) is referred to as a “hopscotch ticketing system.”

The content, end-user (116), and distributor (114) are preferably identified by ID_{C}, ID_{EU}, and ID_{DIST}, respectively. When the end-user (116) selects the content at the distributor's physical location or otherwise obtains the content from the distributor (114), the distributor preferably sends these three IDs to the service center (112). The service center (112) preferably generates a public reference for the end-user (110), PR_{EU}, and uses it and the data shared with the end-user to generate a key for the end-user, K_{EU}. Then, the service center (112) provides ID_{C}, ID_{EU}, ID_{DIST}, and K_{EU} to the content owner (110).

The content owner (110) preferably utilizes ID_{C} to identify the key for the content, K_{C}. The content owner (110) also utilizes ID_{DIST} to identify the data shared with the distributor (114), generates a public reference, PR_{DIST}, and uses the shared data and the public reference to generate a distributor key, K_{DIST}. The content owner (110) encrypts K_{C} with K_{EU} and encrypts the result with K_{DIST} to produce K_{DIST}(K_{EU}(K_{C})). Then, the content owner (110) provides the encrypted K_{C} and PR_{DIST} to the service center (112).

The service center (112) cannot decrypt K_{C} because it lacks access to the shared data held by the distributor (114) and the content owner (110) and, therefore, cannot generate K_{DIST} from PR_{DIST}. The service center (112) preferably sends the encrypted K_{C}, PR_{DIST}, and PR_{EU} to the distributor (114). The distributor (114) utilizes PR_{DIST} and the data shared with the content owner (110) to recreate K_{DIST} and partially decrypt K_{C} to produce K_{EU}(K_{C}). However, the distributor (114) cannot fully decrypt K_{C} because it lacks access to the shared data held by the end-user (116) and the service center (112) and, therefore, cannot generate K_{EU} from PR_{EU}. The distributor (114) provides the partially-decrypted K_{C} and PR_{EU} to the end-user (116). The end-user (116) utilizes PR_{EU} and the data shared with the service center (112) to recreate K_{EU} and decrypt K_{C}. The end-user (116) uses K_{C} to access the content.

In one embodiment, the hopscotch ticketing system (100) is implemented through interactions between user access devices (UASs) (410) and provider access devices (PASs) (412). A UAS (410) preferably includes a processing device (416) and a storage device (418). The storage device (418) preferably holds data and instructions for interacting with a PAS (412), including the shared data and instructions for generating keys.

### BRIEF DESCRIPTION OF THE DRAWINGS

FIGS. 1A and 1B are high-level block diagrams illustrating the sets of entities involved in respective embodiments of the hopscotch ticketing system 100 of the present invention;

FIG. 2 is a transaction diagram illustrating interactions among a content owner 110, service center 112, distributor 114, and end-user 116; and the actions performed by the entities in one embodiment of the hopscotch ticketing system 100;

FIG. 3 illustrates a logical representation of a response 300 utilized in one embodiment of the hopscotch ticketing system 100; and

FIG. 4 is a high-level block diagram illustrating a user access system (UAS) 410 interfacing with a provider access system (PAS) 412 via a communications link 414 according to an embodiment of the hopscotch ticketing system 100.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

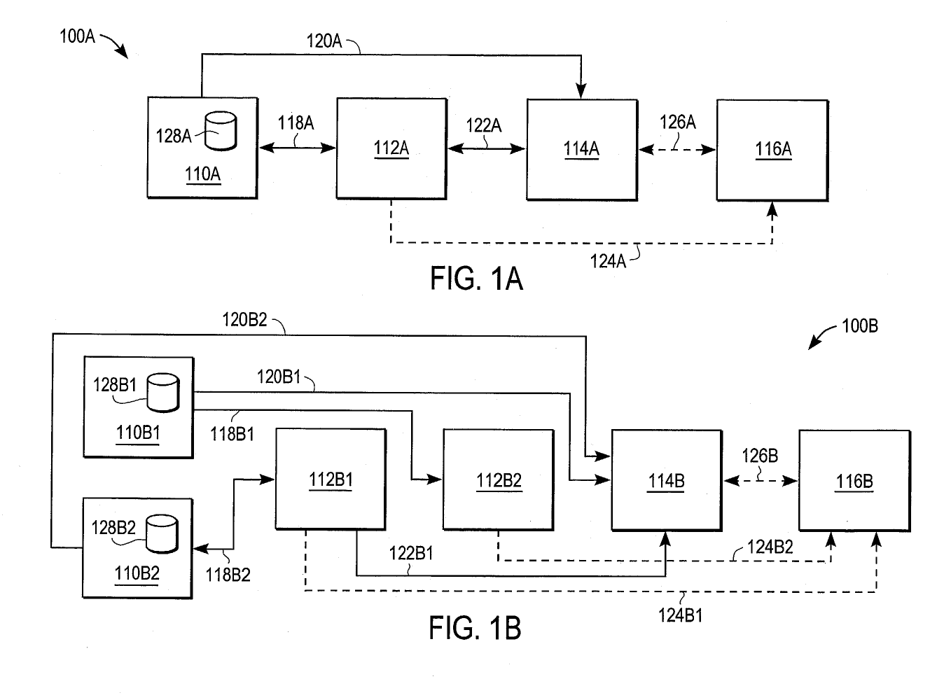

FIGS. 1A and 1B are high-level block diagrams illustrating the sets of entities involved in respective embodiments of the hopscotch ticketing system 100. FIGS. 1A and 1B each illustrate exemplary embodiments of the system 100, and it should be understood that other embodiments of the system can differ from those described herein. In the figures, like elements are identified with like reference numerals. A letter after the reference numeral, such as “100A,” refers specifically to the element having that particular reference numeral. A reference numeral without a following letter, such as “100,” refers to any or all of the elements in the figures bearing that reference number (e.g. “100” in the text refers to reference numerals “100A” and/or “100B” in the figures).

The system 100 allows content to be secured by the one or more owners of the content, stored at remote storage and distribution sites, and then delivered for use by a specific, authorized end-user. The content is preferably digitally encoded data that can be utilized for a specific purpose by the end-user. Examples of digital content include music, movies or other forms of video, software, books, etc. which the user can play, view, execute, read, etc. The content may be stored, and distributed to the end-user, in one or more of a variety of storage media. For example, the content may be stored on optical media such as compact disks (CDs) and DVDs or magnetic media such as floppy or hard disks. In addition, the content may be delivered to the end-user via a conventional retail sale or a computer network such as a cable television network or an Internet connection.

Preferably, the content is digitally encrypted to prevent unauthorized access. An authorized party, typically either a content owner or licensed end-user, can access the content only through the use of an electronic “ticket.” An advantage of the system 100 of FIGS. 1A and 1B is that the ticket and content can reside at the same physical or logical location without compromising access to the content. Due to this advantage, the same storage and distribution channels can be used to distribute the content and ticket to the end-user without the threat of an intermediate party decrypting and pirating the content while it is in the channel.

Turning initially to FIG. 1A, illustrated therein are a content owner 110A, a service center 112A, a distributor 114A, and an end-user 116A. Each illustrated entity in FIG. 1 logically represents the named entity and/or any devices utilized by the entity to perform the functions described herein. For example, the term “end-user” 116 may refer to a person, a computer system, CD player, or other device utilized by the person, or both the person and the device, depending upon the context.

The illustrated content owner 110 is representative of ‘M’ parties, such as persons, corporations, or organizations, that own or control the content, where ‘M’ is a positive integer. In an embodiment where the content is music, for example, the M parties that own or control the content may include the musicians, the publisher, the recording label, etc. Similarly, in the embodiment where the content is software, the M parties that own or control the content may include the developer, the distributor, etc. In another embodiment, the content owner 110 may simply be the copyright holder or other party that controls the content. Regardless, the content owner 110 represents an aggregation of the .M owners into a single logical entity.

Preferably, the content owner 110 encrypts or otherwise obfuscates the content so that the content can only be decrypted with permission from the content owner. In a preferred embodiment, the content owner 110 utilizes a thresholding encryption scheme to encrypt the content. In a thresholding scheme, each of the M individual content owners 110 contributes to the encryption of the content, so that the content can be decrypted only with permission from all M parties. Furthermore, the encryption scheme preferably allows the content to be divided into multiple portions, where different sets of content owners can contribute to the encryption of each portion.

The content owner 110 preferably includes one or more conventional computer systems adapted to perform the functions attributed to the content owner 110. As is known in the art, the computer systems associated with the content owner 110 and other entities described herein are adapted to execute computer program modules for providing the functionality attributed to the respective entities. As used herein, the term “module” refers to computer program logic and/or any hardware or circuitry utilized to provide the specified functionality. Thus, a module can be implemented in hardware, firmware, and/or software.

The content owner 110 preferably has a secure communications link 118 enabling bi-directional communications between the content owner and the service center 112. In addition, the content owner 110 preferably has a secure communications link 120 enabling at least unidirectional communications to the distributor 114. These communications links 118, 120, and the other communications links described herein, preferably utilize conventional communications technology and media except where specified herein. The links 118, 120 may include private links, such as dedicated T1 lines and/or local or wide area networks. The links 118, 120 also may include public links, such as public telephone lines, television distribution systems, or shared Internet connections. The links 118, 120 may utilize conventional communications technologies such as analog modems, digital subscriber line modems, cable modems, Ethernet, etc. Moreover, the links 118, 120 may include intermittent or transitory links. For example, a transitory link may be formed when media embodying the data are physically transported from the content owner 110 to the service center 112.

In one embodiment, data are transmitted over communications links 118 and 120, and the other communications links described herein, via conventional communications protocols such as the hypertext transport protocol (HTTP), the file transfer protocol (FTP), and the transmission control protocol/Internet protocol (TCP/IP). The data may be encoded in the extensible markup language (XML), hypertext markup language (HTML), or any other suitable representation.

In a preferred embodiment, the security of communications links 118 and 120, and the other secure communications links described herein, is provided by encrypting the data carried thereon with an electronic key executive (EKE) as described in more detail below. Accordingly, the communications links 118, 120 can carry data over the public networking infrastructure while still securing the data from unauthorized third party eavesdropping. In other embodiments, the data carried by the links 118, 120 is secured through conventional encryption technologies such as certificates, key authorities, etc. These technologies may be implemented, for example, through the use of the secure sockets layer (SSL). Alternatively, the communications links 118, 120 can be physically secure to prevent eavesdropping by unauthorized third parties.

The service center 112 preferably has a secure bi-directional communications link 118 with the content owner 110, a secure bi-directional communications link 122 with the distributor 114, and a secure communications link 124 to the end-user 116. In one embodiment, the latter link 124 is a transitory link; the end-user 116 is not required to have a direct communication link with the service center 112. The service center 112 preferably includes a conventional computer system adapted to perform the functionality described herein.

The distributor 114 is the distribution point for the encrypted content. The distributor 114 may be, for example, a store selling CDs, DVDs, or other media holding digital content, a warehouse holding the content for eventual distribution to one or more stores, a web site or other networked location making digital content available for download and/or purchase, etc. The distributor 114 preferably has a secure bi-directional communications link 122 with the service center 112, a secure link 120 from the content owner, and at least a transitory communications link (illustrated by dashed arrow 126) with the end-user 116. The transitory communications link 126 may occur, for example, when the end-user 116 is present in the store. In use, the distributor 114 sends information to the service center 112. The service center 112 in turn contacts the content owner 110, and the content owner then forwards a response back to the service center. The service center 112 forwards the response back to the distributor 114, who then communicates it to the end-user 116.

Although not shown in FIG. 1, there may also be a secondary distributor disposed between the illustrated distributor 114 and the end-user 116. A secondary distributor might be a person or other entity having the ability to make copies or otherwise distribute media holding second (or greater) generation copies of the digital content. For example, the secondary distributor may be a person who loans or “burns” a CD. Similarly, the secondary distributor may be a magazine that distributes free copies of the CD for promotional purposes. If the end-user 116 receives the content from a secondary distributor, the end-user is preferably required to contact a primary distributor 114 to obtain authorization (and the ability) to access the content.

Although not shown in FIG. 1, one embodiment of the present invention has one or more escrow agents disposed between the distributor 114 and the service center 112. An escrow agent is an entity having the ability to receive requests from distributors 114, contact the service center 112 on behalf of the distributors, and then send the responses back to the distributors. The service center 112 and content owner 110 still establish communications links as described above, except that the response from the content owner is forwarded through the escrow agent. In one embodiment, the response received by the escrow agent is a threshold response requiring the escrow agent to contact additional escrow agents in order to formulate a complete response for a distributor. An escrow agent, acting alone, cannot access the authorization (i.e., key) for accessing the content. The use of escrow agents provides greater reliability and redundancy.

The end-user 116 is the content recipient. Although only one end-user 116 is illustrated in FIG. 1, embodiments of the system 100 may have thousands or millions of end-users of which the end-user of FIG. 1 is representative (as well as multiple content owners 110, service centers 112, and/or distributors 114). The end-user 116 preferably has communications links 124, 126 with the service center 112 and the distributor 114. In one embodiment, the end-user 116 includes a media player for playing the digital content. For example, the end-user 116 may include a CD player, DVD player, a set-top box (STB), or other form of media player, a computer system for playing content encoded on the media and/or executing software, etc. In one embodiment, the end-user 116 includes a network interface for communicating with the distributor 114 and/or the service center 124. In another embodiment, the end-user 116 includes a different interface for communicating, such as a keypad and display for accepting and displaying data, or an interface for accepting inserted media (of the same or different type than the primary media the end-user 116 is adapted to accept).

One of skill in the art will recognize that the communications links 118A, 120A between the content owner 110A and the distributor 114A are in a parallel relationship with the communications links 122A, 124A between the service center 112A the end-user 116A. The system 100 is called a “hopscotch ticketing system” because certain communications from the content owner 110A to the distributor 114A “skip” over the service center 124A and certain communications from the service center 124A to the end-user 116A “skip” over the distributor 114A.

Alternative embodiments of the hopscotch ticketing system 100 can have multiple content owners 110, service centers 112, and distributors 114. FIG. 1B illustrates such an embodiment having multiple content owners 110B1, 110B2 and service centers 112B1, 112B2. In FIG. 1B, the content owners are respectively labeled 110B1 and 110B2. and the service centers are respectively labeled 112B1 and 112B2. The communications links among the various entities are similarly labeled. In the embodiment of FIG. 1B, content owner 110B1 is in communication with service center 112B2 and the distributor 114B via communications links 118B1 and 120B1, respectively. Similarly, content owner 110B2 is in communication with service center 112B1 and the distributor 114B via communications links 118B2 and 120B2, respectively. These entities and links preferably function in the same manner as do the entities and links of FIG. 1A. Different permutations of the entities and links are possible.

In use, the content owner 110 preferably generates a ticket. Then, the content owner 110 uses the ticket and one or more public references to generate multiple second unique keys. The public references may be determined from a media format of the content (e.g., DVD, CD, etc.) or may be artificially generated and stored on the media (in plaintext) or at another publicly-accessible location. The content owner uses the second keys generated from the ticket to encrypt specific portions of the content on the media. As a result of this technique, the data size of the keys can effectively be equal to the data size of the content.

One must have access to the unencrypted ticket, the encrypted content, and the public references in order to generate the second keys and decrypt the specific portions of the content on the media. Each piece of content is preferably encrypted with keys based upon a different ticket, and the content owner 110 preferably stores a database 128 associating content and tickets. However, the content owner 110 has flexibility in deciding how many different tickets to use. For example, in one embodiment every CD is encrypted with a different ticket and in another embodiment every CD title is encrypted with the same ticket, but different CD titles are encrypted with different tickets.

The ticket is occasionally referred to herein as the “content key” or the content's “encryption” or “decryption” key. This terminology is utilized because the ticket is preferably required in one embodiment in order to generate the actual keys used for encrypting and decrypting the content. Therefore, the ticket serves as the key to the content, even though the ticket is not directly applied to the content or used as a “key” in the traditional cryptographic sense.

Preferably, the content owner 110 generates the tickets from random (or pseudo-random) data generated or otherwise derived by the content owner. Embodiments of the system 100 can use one or more conventional hashing and/or encryption techniques to generate the second keys from the tickets and public references, and to encrypt and decrypt the content, second keys, and tickets. Such techniques include the Secure Hash Algorithm (SHA-1), the Advanced Encryption Standard (AES), the Data Encryption Standard (DES), Skipjack, and Rivest, Shamir, and Adleman (RSA) encryption and variants thereof. Preferably, the encrypted content is identical in size, or only minimally larger than, the encrypted content.

Embodiments of the system 100 utilize symmetric and/or asymmetric encryption. In symmetric encryption, the encryption and decryption keys are the same. Thus, the ticket and second keys, when used with the public references, can encrypt and decrypt the content. In asymmetric encryption, the encryption and decryption keys are different. Thus, different tickets and/or second keys are used with the public references to encrypt and decrypt the content. In addition, embodiments of the system 100 may utilize public-key cryptography (a form of asymmetric encryption). The encryption/decryption techniques utilized in embodiments of the system 100 can vary depending upon the particular embodiments or needs of the system. In this description, the tickets and second keys used for encryption and decryption are assumed to be the same, even though the encryption and decryption keys may, in fact, be different.

Preferably, the content owner 110 causes encrypted content to be distributed to the distributor 114. The distributor 114 does not have access to the tickets and cannot access the content or allow others to access the content. Since in a preferred embodiment there are multiple distributors 114, this technique allows the content to be forward-cached at multiple strategic locations, which reduces both the need for physical storage of content as well as the incurrence of bandwidth at the time downloadable content is requested.

In one embodiment, a license distributor is interposed between the distributor 114 and the service center 112 illustrated in FIG. 1A. The license distributor communicates with the service center 112 and obtains data allowing the license distributor to assume the role of the service center 112 with respect to all or a subset of distributors. The license distributor also communicates with the distributor 114 and obtains data allowing the license distributor to assume the role of the distributor with respect to the content owner 110. This embodiment allows the ticket (i.e., license) distribution functionality to be delegated to an entity able to more efficiently communicate with the distributor. For example, in one embodiment the license distributor is an entity that traditional provides point-of-sale transaction services to the distributors, thereby allowing the entity to incorporate the ticket distribution process into normal point-of-sale transactions.

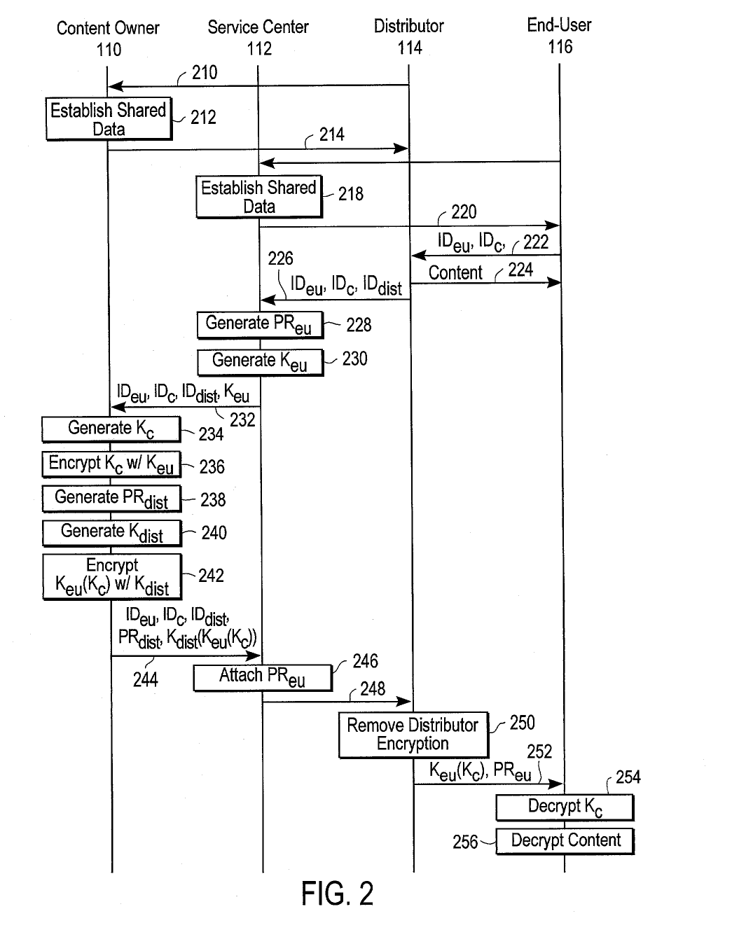

FIG. 2 is a transaction diagram illustrating interactions among the content owner 110, service center 112, distributor 114, and end-user 116, and the actions performed by the entities. In FIG. 2, time flows from top to bottom, although the time scale is not necessarily linear. The horizontal arrows represent interactions among the entities. FIG. 2 shows major interactions, but does not necessarily illustrate every one. Alternative embodiments of the system 100 may utilize different or additional interactions. In addition, the order of the interactions may vary, and some interactions may occur asynchronously with respect to others.

The distributor 114 preferably registers 210 itself with the content owner 110 either directly or through another entity. As part of the registration, the distributor 114 preferably provides the content owner 110 with an identification, ID_{DIST} (Distributor ID), that uniquely identifies the distributor 114. The content owner 110 preferably establishes 212 a unique value through the use of random number generation or similar means, and associates the unique value with the ID_{DIST}. Then, the content owner 110 sends 214 the unique value to the distributor 114, or provides the distributor with instructions for recreating the value. In the Personal Access Management System (PAMS) embodiment, described in more detail below, these steps are accomplished by exchanging and updating EKEs. The unique value is referred to as “shared data” or “shared secret data” because it is known to only the content owner 110 and the distributor 114. In one embodiment, the shared data is encoded into a device utilized by the distributor 114 to communicate with the content owner 110. Since the shared data may be encoded into the device prior to the device being distributed to the distributor 114, the distributor might not know the specific shared data. The registration process between the distributor 114 and the content owner 110 delineated by transactions 210, 212, and 214 is preferably performed before the other transactions illustrated in FIG. 2.

In a similar fashion, the end-user 116 preferably engages in a registration process with the service center 112. FIG. 2 delineates this registration process with transactions 216, 218, and 220. During registration, the end-user 116 preferably provides the service center 112 with an identification, ID_{EU} (end-user ID) that uniquely identifies the end-user. In a preferred embodiment of the system 100, the ID_{EU} does not contain personally identifiable data. Therefore, the end-user 116 remains anonymous despite providing the ID_{EU} to the service center 112. This registration process is preferably performed asynchronously with respect to the other transactions illustrated in FIG. 2 (although it must occur before the end-user 116 is able to decrypt the content). In one embodiment, the secret data shared between the end-user 116 and the service center 112 is encoded in an end-user device during manufacture and can be associated and accessed via an external ID (e.g., SKU number, serial number, etc.) and an anonymous end-user name (e.g., ID_{EU}).

The content owner 110 and distributor 114, and service center 112 and end-user 116, utilize their respective knowledge of their respective shared secret data to engage in secure communications with each other. In a simple embodiment, the shared data are utilized as a symmetric key for encrypting and decrypting messages exchanged between the respective two entities, or the shared data are utilized as an asymmetric key pair to support at least unidirectional message exchanges. In a preferred embodiment, however, the key is derived from the shared data. For example, the content owner 110 can utilize the shared data to generate a key by combining or modifying the shared data with other data such as a public reference. Then, the content owner 110 can supply the public reference to the distributor 114 with the encrypted message. The distributor 114 can recreate the key by combining or modifying the public reference with its copy of the shared data and then decrypt the message. Eavesdroppers who obtain the message and the public reference are unable to recreate the key and, therefore, cannot decrypt the message. Those of skill in the art will recognize that many techniques can be utilized to generate a key from shared data and a public reference.

The shared data held by the two entities are not necessarily identical. In one embodiment, the shared data includes an asymmetric key pair allowing only unidirectional communications. For example, the service center 112 can hold an encryption key as its shared data while the end-user 116 holds a paired decryption key as its shared data. Similarly, each entity's shared data can include an encryption key and a decryption key, allowing bi-directional communications between the entities. In another embodiment, the shared data includes a private key for a public-key encryption system. In this latter embodiment, the “establish shared data” transactions 212, 218 can include obtaining the other entity's public key. Then, the parties can communicate by encrypting messages utilizing the public key and decrypting messages utilizing their respective private keys. Thus, the shared data can be utilized to provide secure unidirectional and secure bi-directional communications. Those of skill in the art will recognize that variations of these techniques are possible and within the scope of the present invention.

At transaction 222, the end-user 116 requests specific content from the distributor 114. As stated above with respect to FIG. 1, transaction 222 can occur, for example, when the customer purchases a CD from a music store, downloads content from the Internet, buys a magazine from a newsstand, etc. As part of this transaction 222, the end-user 116 provides the distributor 114 with the ID_{EU} and an ID_{C}, (Content ID—a reference to the specific content).

In response, the distributor 114 provides 224 the content identified by ID_{C} to the end-user 116. The content delivery 224 may occur in an asynchronous transaction occurring at any point after the content is requested by the end-user 116. The content is encrypted and the end-user 116 is unable to access it without the ticket. Depending upon the specific embodiment of the system 100, therefore, the distributor 114 may provide 224 the content to the end-user 116 concurrent with the end-user's receipt of the ticket (i.e., the authorization to access the content) or at some other time.

The distributor 114 preferably sends 226 the service center 112 a message specifying ID_{EU}, ID_{C}, and an identification, ID_{DIST} (distributor ID), that uniquely identifies the distributor. Preferably, the distributor 114 sends this message via the secure communications link 122 between the distributor and the service center 112. The service center 112 preferably utilizes the data received from the distributor 114 to generate 228 a public reference, PR_{EU}, and a key, K_{EU} for the end-user 116.

In one embodiment, the service center 112 generates 228 PR_{EU} randomly. In another embodiment, the service center 112 utilizes the received ID_{EU} to look up and access the shared data generated for the identified end-user 116 at transaction 218. The service center 112 then derives the public reference from the shared data. In yet another embodiment, the service center 112 generates an initial value for the public reference when it receives a first authorization request from the end-user identified with the ID_{EU} and applies a standard operation to (e.g., increments) the initial value to generate a new public reference for each subsequent authorization request from that end-user. In an alternative embodiment, the service center 112 generates and stores the public references and/or associated keys in advance of receiving specific content requests from the distributor 114. The service center 112 may store the public references and/or associated keys with one or more third parties who can act on behalf of the service center 110. The public references and/or associated keys may be distributed so that “acting on behalf of the service center 112” requires participation by more than one of the third parties.

The service center 112 preferably utilizes PR_{EU} and the data shared with the end-user to generate 230 a key for the end-user 116, K_{EU}. As described above, K_{EU}, PR_{EU}, and the shared data are preferably related such that, given access to PR_{EU} and the shared data, the end-user 116 can generate K_{EU} and thereby decrypt content encrypted with K_{EU}. Without the shared data, however, decryption is practically impossible (i.e., not computationally feasible). Thus, if the service center 112 encrypts content with K_{EU} and provides PR_{EU} to the end-user 116, only the end-user can decrypt the content because only the end-user can generate K_{EU}.

The service center 112 preferably sends 232 the content owner 110 a message specifying ID_{EU}, ID_{C}, ID_{DIST}, and the K_{EU} generated by the service center 112, or some combination or variation thereof. For example, the ID_{EU} and/or ID_{C} sent by the service center 112 to the content owner 110 is not necessarily the same ID_{EU}/ID_{C} received from the end-user 116, although the server center 112 must maintain a database indicating the equivalence of the two ID_{EU}s/ID_{C}s. With this message, the service center 112 requests the ticket (i.e., the data used to create the keys used to encrypt the content) for the content identified by the ID_{C}. Preferably, the service center 112 sends this message via the secure link 118 between the service center and the content owner 110.

Upon receiving the ticket request from the service center 112, the content owner 110 preferably locates the ticket, K_{C}, for the identified content. Preferably, K_{C} can be used in combination with the public references stored with the content (or at another publicly-accessible location) to generate the second keys for decrypting the content. In an alternative embodiment, K_{C} can be applied directly to the content.

The content owner 110 preferably encrypts 236 K_{C} using the K_{EU} it received from the service center 112, thereby producing K_{EU}(K_{C}). This value, K_{EU}(K_{C}), is called the “encrypted ticket.” The content owner 110 also preferably generates 238 a public reference for the distributor 114, PR_{DIST}, and generates 240 a key, K_{DIST}, for the distributor. PR_{DIST} and K_{DIST} are preferably generated from the shared data established during transaction 212 using the same techniques described above with respect to PR_{EU} and K_{EU}. The content owner 110 then preferably encrypts the encrypted ticket with K_{DIST} to produce K_{DIST}(K_{EU}(K_{C})). The content owner 110 preferably appends PR_{DIST} to K_{DIST}(K_{EU}(K_{C})) to form a response to the service center 112.

The content owner 110 preferably sends 244 the response to the service center 112 using the secure communications link 118. The content owner 110 also preferably provides the service center 112 with ID_{EU}, ID_{C}, and ID_{DIST}. The service center 112 utilizes these latter data to identify the public reference for the end-user, PR_{EU}, generated at transaction 228. Once identified, the service center 112 preferably attaches 246 PR_{EU} to the response received from the content owner 110.

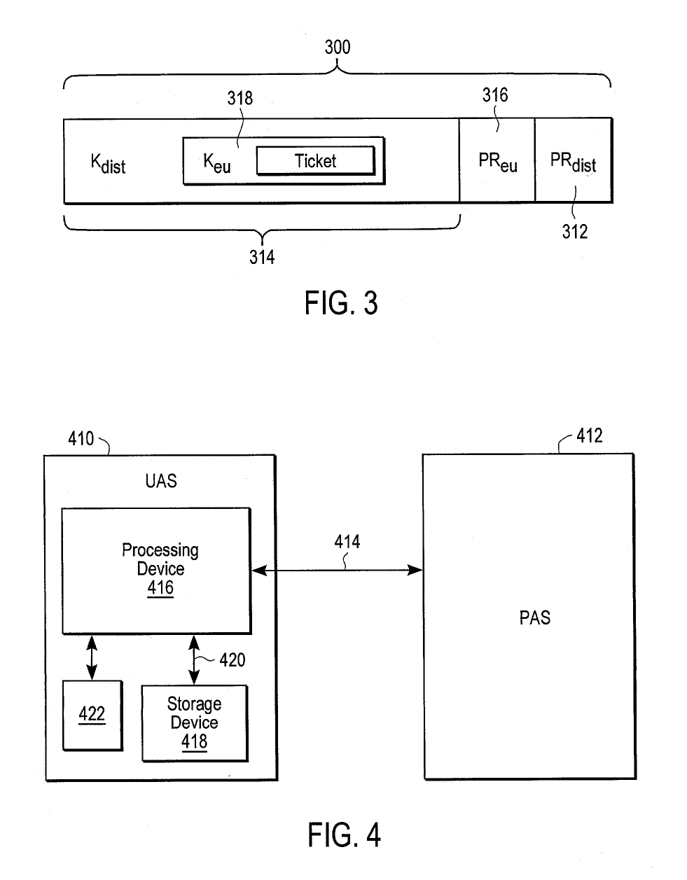

FIG. 3 illustrates a logical representation of the response 300 after the service center 112 attaches PR_{EU}. Those of skill in the art will understand that the physical representation of data does not necessarily resemble the illustrated response 300. In this embodiment, the response 300 preferably contains two layers of encrypted information. The first layer contains the public reference 312 for the distributor 114, PR_{DIST}, and the value K_{DIST}(K_{EU}(K_{C})) (identified by reference numeral 314). The second layer contains the public reference 316 for the end-user 116, PR_{EU}, and the value K_{EU}(K_{C}) (identified with reference numeral 318).

The service center 112 is unable to access the content identified by the ID_{C} for at least two reasons. First, the service center 112 does not have access to the content. Second, even if the service center 112 is able to access the content, it cannot decrypt the ticket because it does not have access to the distributor's shared data and cannot utilize PR_{DIST} 312 to generate K_{DIST} and decrypt K_{DIST}(K_{EU}(K_{C})).

The service center 112 preferably sends 248 the response 300 to the distributor 114 using the secure communications link 122. The service center 112 also preferably provides the distributor 114 with ID_{EU} and ID_{C}. The distributor 114 preferably utilizes PR_{DIST} 312 and the data shared with the content owner 110 at transaction 212 to generate K_{DIST}. Then, the distributor 114 utilizes K_{DIST} and the shared data to remove 250 the distributor encryption from the response 300, thereby producing the encrypted ticket 318, K_{EU}(K_{C}).

Although the distributor 114 has access to the encrypted content and PR_{EU}, it cannot generate K_{EU} because it lacks access to the shared data necessary to do so. Accordingly, the distributor 114 cannot decrypt the content.

The distributor 114 preferably sends 252 the encrypted ticket 318 and PR_{EU} 316 to the end-user 116. When the end-user wishes to access the media, the end-user 116 preferably utilizes PR_{EU} 316 and the shared data established with the service center 112 at transaction 218 to generate K_{EU}. Then, the end-user 116 preferably utilizes K_{EU} and the shared data to decrypt 254 the encrypted ticket, K_{EU}(K_{C}), and obtain the ticket, K_{C}. The end-user 116 can then use the ticket to decrypt 256 the content received from the distributor 114 at transaction 224.

In one embodiment, the end-user stores PR_{EU}, the shared data, and the encrypted ticket in a portable device such as a smart card, which in turn has established shared secret data with some number of authorized media appliances. When the end-user 116 is ready to access content in a media appliance, the portable device forms a communication channel with that appliance. For example, the end-user 116 may insert the portable device into a matching interface of the appliance. The portable device has the capability to utilize PR_{EU} and the shared data established at transaction 218 to generate K_{EU}. Then, the portable device preferably utilizes K_{EU} to decrypt the encrypted ticket, K_{EU}(K_{C})), and obtain the ticket, K_{C}. The portable device further has the capability to generate a PR_{MA}, the public reference for the media appliance it is interfacing with, and a K_{MA}. The portable device encrypts the ticket K_{C} in K_{MA}, resulting in an encrypted ticket K_{MA}(K_{C}). The portable device preferably sends both the encrypted ticket K_{MA}(K_{C}) and PR_{MA} to the appliance and the appliance utilizes PR_{MA} and the shared data to generate K_{MA}. Then, the appliance utilizes K_{MA} to decrypt the encrypted ticket, K_{MA}(K_{C}), and obtain the ticket K_{C}. The appliance then uses the ticket to generate the keys for decrypting the content received from the distributor 114.

In the embodiment of the system 100 utilizing a license distributor interposed between the distributor 114 and the service center 112, the service center preferably provides a limited number of pre-generated PR_{EU}s and K_{EU}s for particular ID_{EU}s to the license distributor (or provides data allowing the license distributor to generate the PR_{EU}s and K_{EU}s). When the distributor 114 receives an ID_{EU} and ID_{C} from an end-user 116, the distributor passes these two IDs to the license distributor. The license distributor uses the ID_{EU} to locate a pre-generated PR_{EU} and K_{EU} for the end-user 116, and communicates the ID_{EU}, ID_{C}, K_{EU}, to the content owner 110. The content owner 110 sends the response back to the license distributor. The license distributor attaches PR_{EU} to the response and sends it to the distributor 114 for distribution to the end-user 116. The service center 112 periodically replenishes the PR_{EU}s and K_{EU}s stored at the license distributor and also communicates with the content owner 110 for accounting purposes.

FIG. 4 is a high-level block diagram illustrating a user access system (UAS) 410 interfacing with a PAS 412 via a communications link 414 established with an EKE. The UAS 410 is representative of the device utilized by the end-user 116 to interact with the service center 112 and, optionally, the distributor 114 (in the case of an online or remote transaction). The UAS 410 is also representative of the device utilized by distributor 114 when interacting with the service center 112 and the content owner 110.

The PAS 412, in contrast, is representative of the device optionally utilized by the distributor 114 to interact with the end-user 116 (in the event of an online or remote transaction), utilized by the content owner 110 to interact with the service center 112 and distributor, and utilized by the service center 112 to interact with the distributor and end-user. In addition, the PAS 412 may be a smart card or other portable device that the end-user 116 uses to decrypt tickets for itself and then, based on knowledge of shared secret information, to decrypt authorization for a specific player(s) or UAS 410.

The communications link 414 is representative of any of the secure communications links illustrated in FIG. 1, including the transitory links. Those of skill in the art will recognize that FIG. 4 is intended to represent the functionality of the illustrated devices and not necessarily the physical hardware of the device. Thus, the device utilized by the distributor 114 resembles the functionality of the UAS when the distributor is communicating with the content owner 110, and the functionality of the PAS when the distributor is communicating with the end-user 116.

The UAS 410 preferably includes a processing device 416 and a storage device 418. The processing device 416 is preferably a conventional specific- or general-purpose processor. In one embodiment, the UAS 410 utilized by the end-user 116 is an electronic device such as a CD player, DVD player, or other form of media player, a computer system for playing content encoded on the media and/or executing software, etc. As such, the processing device 416 may be incorporated into a processor for controlling the electronic device, or a standalone processor in communication with the electronic device. In another embodiment, the UAS 410 is a stand-alone device.

The storage device 418 may take on a number of different forms including magnetic media (e.g., hard and/or floppy disks, magnetic strip cards, etc.), optical media (e.g., CD-ROM), and semiconductor memory (e.g., RAM, PROM, flash memory, EPROM, PCMCIA cards, or smart cards), or any other memory suitable for the purposes described herein. The storage device 418 preferably couples to the processing device 416 via a suitable interface 420 to form a single, logical UAS 410. Depending upon the embodiment, the storage device 418 and processing device 416 may reside within a single integrated circuit, on a single circuit board, within a single device, etc.

In one embodiment, the processing device 416 provides processing capability, communications interface capability, and a user interface for the PAS 410. The processing device 416 preferably contains only a minimum of software instructions. Hence, on its own, the processing device 416 is preferably incapable of communicating or transacting with the PAS 412.

Preferably, the storage device 418 provides the specific program instructions and data utilized by the processing device 416 to operate and interact with the PAS 412. To this end, the storage device 418 preferably contains: (1) a management program which controls interaction between the processing device 416 and the storage device 418, and interaction between the UAS 410 and the PAS 412; (2) a provider-specific program which generates the messages (referred to herein as “session codes”) to be sent to the PAS 412; and (3) user-specific data which are used and manipulated by the two programs. The processing device 416 preferably accesses and executes the instructions stored on the storage device 418 once the storage device is coupled thereto.

The same UAS 410 may be used to communicate with a number of different PAS's. A user need only have the requisite information (i.e., EKE) accessible to the processing device 416 in order to communicate with a different PAS 412. This aspect of the UAS 410 is advantageous because it significantly limits the cost to the end-user 116 when utilizing the system 100, since the end-user is required to invest in just a single UAS 410 and/or storage device 418. Since it is contemplated that storage devices will be provided to end-users at little or no cost, the cost to the end-user is kept to a minimum. In another embodiment, a single storage device 418 contains data and/or instructions enabling it to communicate with multiple processing devices and/or PAS's.

In one embodiment, the storage device 418 contains the EKE that is used by the UAS 410 to establish shared information, hash codes, and key codes. These codes are used to generate recognition parameters and session codes, which are preferably held in an encrypted form in a memory 422 of the UAS 410. In one embodiment, a dedicated storage device 418 having a master EKE is used to establish an initial set of codes. The master EKE may be applied to the UAS 410, for example, during manufacture of the UAS or when the UAS is first used by the end-user 116.

The recognition parameters and session codes generated from the master EKE are preferably utilized to enforce a recognition and authentication methodology between the UAS 410 and other storage devices 418 containing “regular” EKEs. Thus, the recognition parameters and session codes generated with the master EKE preferably lock the UAS 410 so that it accepts or can access only authorized storage devices and/or stored information. If an authorized storage device 418 having a regular EKE interfaces with the processing device 416 of the UAS 410, then the UAS 410 is able to decrypt the contents of the storage device and access the data and instructions stored therein. The UAS 410 is preferably unable to decrypt the contents of an unauthorized storage device 418.

Storage devices having regular EKEs are preferably utilized to control communications between the UAS 410 and the PAS 412. Once a storage device 418 having a regular EKE is recognized by the UAS 410, the UAS preferably decrypts a Personal Access Management System (PAMS) File Manager (PFM) stored on the storage device 418. The PFM is the main program which is accessed and executed by the processing device 416 to coordinate interaction between the UAS 410 and PAS 412. The PFM can be unencrypted, although it is preferably stored in a tamper-resistant or tamperproof medium. The regular EKE preferably contains instructions and/or data from which the PFM generates the messages and/or session codes which the UAS 410 and PAS 412 utilize to interact.

Since a storage device 418 and its PFM are associated with at least one particular PAS 412, the session codes generated by the PFM are known to (or at least can be interpreted by) the PAS. Thus, the use of the regular EKE corresponds to the “registration” 210, 216 and “establish shared data” 212, 218 transactions illustrated in FIG. 2. The storage device 418 is preferably created and loaded with data and/or instructions for generating particular session codes.

When the PAS 412 receives a communication generated by the storage device 418, UAS 410, or end-user 116, the PAS 412 preferably uses disclosed public information along with the shared data to generate session codes and utilizes these codes to engage in communications with the UAS 410. Thus, the UAS 410 and PAS 412 use their shared knowledge of how to generate the session codes to communicate securely. These uses of the master and regular EKEs, PFM, and other aspects of the UAS 110 and PAS 412 are described in more detail in U.S. Pat. No. 5,619,574.

Consider the following illustrative use of the system described in FIGS. 1-4 to provide an end-user with access to encrypted content. Assume that a record store has encrypted content, such as music or videos, available for purchase (or license) by an end-user. The encrypted content can include pre-mastered physical copies, such as shrink-wrapped CDs, or data copies stored on a kiosk that can burn CDs or other removable media.

Also assume that the end-user has a smart card, or similar portable storage device, that the end-user obtained from the record store or another source. The smart card has a unique serial number (i.e., the ID_{EU}) and holds a unique value (i.e., the shared data, which is serving as an EKE). Alternatively, the smart card holds an anonymous ID (i.e., a “handle”) selected by the user for use as ID_{EU}. The shared data and ID_{EU} are preferably encoded into the card during manufacture, when the end-user took possession of the card, or at some other time. In another embodiment, ID_{EU} is not stored on the card, but is instead supplied by the end-user at the time of purchase.

Once the end-user selects a CD, the end-user approaches the record store's checkout in order to purchase it. The record store has a device, such as a computer terminal, that functions as a UAS. The UAS has a communications link, such as a telephone connection, with the service center (i.e., the PAS). The record store UAS and the PAS use identifying information (which can be unsecured) to identify their shared secret data and then use the shared data to establish a secure communications link.

The end-user inserts the smart card into the record store's UAS and, if necessary, provides ID_{EU} and the ID_{C} for the content being purchased. The end-user can provide ID_{C}, for example, by scanning a bar code on the content, by inserting the content into a reader at the UAS, or by manually typing ID_{C} into the UAS via a keyboard.

The record store's UAS sends ID_{EU}, ID_{C}, and ID_{DIST} (known to the UAS) to the service center PAS. The interactions between the content owner 110 and the service center 112 illustrated in FIG. 2 occur quickly, and the UAS at the record store soon receives the encrypted ticket and associated PR_{EU} from the service center. The record store UAS causes the encrypted ticket and PR_{EU} to be stored in the end-user's smart card as part of an EKE and PFM.

Later, the end-user takes the CD home and inserts it into a CD player. In addition, the end-user inserts the smart card into a suitable interface in the CD player. The CD player uses the EKE and PFM in the smart card to decrypt the ticket and play the CD.

With this system, the end-user is free to fully exploit the CD. For example, the end-user can play the CD without any degradation caused by the encryption or other security schemes. In addition, the end-user can “burn” backup copies of the CD, and can play the CD in a car stereo (assuming the car stereo has an interface accepting the smart card). In addition, the end-user can give a copy of the CD to another person, who can then obtain a ticket for playing the CD from the record store or another location.

Thus, the hopscotch ticketing system 100 allows a content owner to fully protect content without interfering with the end-users' ability to enjoy it.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for controlling access to encrypted content, comprising the steps of:
distributing encrypted content to a distributor, the content identified by a content identification (ID) and the distributor identified by a distributor ID;
receiving the content ID, the distributor ID, and an end-user ID identifying an end-user seeking access to the content from the distributor identified by the distributor ID;
identifying a key for the content identified by the content ID;
encrypting the key for the content, wherein the key for the content can be decrypted by only the end-user identified by the end-user ID; and
providing the encrypted key for the content to the end-user identified by the end-user ID.

2. The method of claim 1, wherein:
the receiving step comprises the substep of:
generating an encryption key responsive to the end-user ID; and
the step of encrypting the key for the content comprises the substep of:
encrypting the key for the content taking into account the encryption key generated responsive to the end-user ID.

3. The method of claim 2, further comprising the step of:
establishing shared secret data with the end-user identified by the end-user ID;
wherein the step of generating the encryption key responsive to the end-user ID generates the encryption key responsive to the data shared with the identified end-user.

4. The method of claim 3, wherein the encryption key comprises a symmetric encryption/decryption key.

5. The method of claim 3, wherein the encryption key comprises an asymmetric key.

6. The method of claim 3, wherein the end-user is adapted to use the shared data and a public reference to generate a key for decrypting the key for the content.

7. The method of claim 2, further comprising the step of:
generating a public reference responsive to the end-user ID;
wherein the identified end-user utilizes the public reference and the encryption key generated responsive to the end-user ID to decrypt the encrypted key for the content.

8. The method of claim 1, wherein:
the providing step comprises the substep of:
attaching a public reference associated with the identified end-user to the encrypted key for the content; and
the identified end-user utilizes the public reference to decrypt the encrypted key for the content.

9. The method of claim 1, wherein the step of encrypting the key for the content comprises the substep of:
encrypting the key for the content with multiple levels of encryption;
wherein a first level of encryption can be decrypted by only the distributor identified by the distributor ID and a second level of encryption can be decrypted by only the end-user identified by the end-user ID.

10. The method of claim 9, wherein:
the providing step comprises the substep of:
providing the encrypted key for the content to the distributor identified by the distributor ID; and
the distributor decrypts the first level of encryption from the key for the content and provides the key for the content encrypted with the second level of encryption to the end-user.

11. The method of claim 9, wherein:
shared data is established with the distributor identified by the distributor ID; and
the step of encrypting the key with multiple levels of encryption comprises the substeps of:
generating a key for the distributor and a public reference for the distributor responsive to the shared data;
generating the first level of encryption responsive to the key for the distributor and the public reference for the distributor; and
attaching the public reference for the distributor to the encrypted key for the content.

12. The method of claim 1, wherein:
shared data is established with the end-user identified by the end-user ID and wherein the step of encrypting the key for the content comprises the substeps of:
generating a key for the end-user and a public reference for the end-user responsive to the shared data;
encrypting the key for the content responsive to the key for the end-user and the public reference for the end-user; and
attaching the public reference for the end-user to the encrypted key for the content; and
the identified end-user can utilize the shared data and the public reference to decrypt the encrypted key for the content.

13. The method of claim 1, wherein the end-user is adapted to decrypt the encrypted key for the content and use the decrypted key for the content and public references associated with the content to decrypt the content.

14. A method for controlling access to encrypted content, comprising the steps of:
establishing a first secure communications relationship between a first system and a second system, and a second secure communications relationship between the first system and a third system;
establishing a third secure communications relationship between the second system and the third system and a fourth secure communications relationship between the second system and a fourth system;
receiving, via the first secure communications relationship, an identification of the encrypted content;
generating, responsive to the received identification, a response including a decryption key for the content, the response encrypted with a plurality of levels of encryption; and
providing, via the first and third secure communications relationships, the response to the third system;
wherein:
the third system is adapted to remove a level of encryption from the response to produce a partially-decrypted response and provide the partially-decrypted response to the fourth system via the fourth secure communications relationship; and
the fourth system is adapted to decrypt the partially-decrypted response and access the decryption key for the encrypted content.

15. The method of claim 14, wherein the step of receiving an identification of the encrypted content comprises the substep of:
receiving an identification of the fourth system, wherein a level of encryption of the response can be decrypted by only the identified fourth system.

16. The method of claim 14, further comprising the step of:
receiving a key associated with the fourth system, wherein a level of encryption of the response is generated responsive to the key associated with the fourth system.

17. The method of claim 16, further comprising the step of:
establishing, via the fourth secure communications relationship, shared secret data between the second system and the fourth system, wherein the key associated with the fourth system is generated responsive to the shared data.

18. The method of claim 17, wherein the key associated with the fourth system comprises a symmetric encryption/decryption key.

19. The method of claim 17, wherein the key associated with the fourth system comprises an asymmetric key.

20. The method of claim 17, wherein the fourth system is adapted to use the shared data and a public reference to generate the key associated with the fourth system.

21. The method of claim 14, wherein the step of receiving an identification of the encrypted content comprises the substep of:
receiving an identification of the third system, wherein a level of encryption of the response can be decrypted by only the identified third system.

22. The method of claim 14, further comprising the step of:
establishing, via the second secure communications relationship, shared secret data between the first system and the third system.

23. The method of claim 22, wherein the shared data comprises a symmetric encryption/decryption key.

24. The method of claim 22, wherein the shared data comprises asymmetric encryption/decryption keys.

25. The method of claim 22, wherein the third system is adapted to use the shared data and a public reference to generate a symmetric encryption/decryption key.

26. The method of claim 22, wherein the generating step comprises the substep of:
generating a level of encryption of the response responsive to the data shared between the first system and the third system.

27. The method of claim 22, wherein the third system is adapted to utilize the shared data to remove the level of encryption from the response.

28. A method for controlling access to encrypted content, comprising the steps of:
receiving an identification of the encrypted content;
generating, responsive to the identification of the encrypted content, a response including a decryption key for the content, the response encrypted with a plurality of levels of encryption; and
providing the response to a distributor system;
wherein:
the distributor system is adapted to remove a level of encryption from the response to produce a partially-decrypted response and provide the partially-decrypted response to an end-user system; and
the end-user system is adapted decrypt the partially-decrypted response and access the decryption key for the encrypted content.

29. The method of claim 28, wherein the step of receiving an identification of the encrypted content comprises the substep of:
receiving an identification of the end-user system, wherein a level of encryption of the response can be decrypted by only the identified end-user system.

30. The method of claim 28, further comprising the step of:
receiving a key associated with the end-user system, wherein a level of encryption of the response is generated responsive to the key associated with the end-user system.

31. The method of claim 30, further comprising the step of:
establishing shared secret data between a service center system and the end-user system, wherein the key associated with the end-user system is generated responsive to the shared data.

32. The method of claim 31, wherein the key associated with the end-user system comprises a symmetric encryption/decryption key.

33. The method of claim 31, wherein the key associated with the end-user system comprises an asymmetric encryption key.

34. The method of claim 31, wherein the end user is adapted to use the shared data and a public reference to generate a key for decrypting the partially-decrypted response.

35. The method of claim 28, wherein the step of receiving an identification of the encrypted content further comprises the substep of:
receiving an identification of a distributor system, wherein a level of encryption of the response can be decrypted by only the identified distributor system.

36. The method of claim 28, further comprising the step of:
establishing shared data with the distributor system.

37. The method of claim 36, wherein the shared data comprises a symmetric encryption/decryption key.

38. The method of claim 36, wherein the shared data comprises asymmetric encryption/decryption keys.

39. The method of claim 36, wherein the distributor system is adapted to use the shared data and a public reference to generate a key for removing a level of encryption from the response.

40. The method of claim 36, wherein the generating step comprises the step of:
generating a level of encryption of the response responsive to the data shared with the distributor system.

41. The method of claim 36, wherein the distributor system is adapted to utilize the shared data to remove the level of encryption from the response.

42. A system for controlling access to encrypted content, the system comprising:
a distributor having the encrypted content;
a service center adapted to communicate with an end-user and the distributor, the service center having secret data shared with the end-user; and
a content owner adapted to communicate with the service center and the distributor, the content owner having secret data shared with the distributor;
wherein:
the distributor is adapted to provide the content to an end-user responsive to receiving an end-user ID identifying the end-user and a content ID identifying the content, provide the end-user ID, content ID, and a distributor ID identifying the distributor to the service center, remove a second level of encryption from a key for the content identified by the content ID, and provide the key for the content identified by the content ID to the end-user;
the service center is adapted to generate a key for the end-user responsive to the end-user ID and the data shared with the end-user, and to provide the end-user ID, content ID, distributor ID, and key for the end-user to the content owner; and
the content owner is adapted to generate the key for the content responsive to the content ID, encrypt the key for the content with the key for the end-user to produce a first level of encryption, generate a key for the distributor responsive to the distributor ID and the data shared with the distributor, encrypt the key for the content with the key for the distributor to produce the second level of encryption; and provide the key for the content to the distributor.

43. The system of claim 42, wherein the data shared by the service center with the end-user comprises a symmetric encryption/decryption key.

44. The system of claim 42, wherein the data shared by the service center with the end-user comprises an asymmetric decryption key.

45. The system of claim 42, wherein the service center and the end user are adapted to use the shared data and a public reference to generate the key for the end-user.

46. The system of claim 42, wherein the data shared by the content owner with the distributor comprises a symmetric encryption/decryption key.

47. The system of claim 42, wherein the data shared by the content owner with the distributor comprises an asymmetric decryption key.

48. The system of claim 42, wherein the content owner and the distributor are adapted to use the shared data and a public reference to generate the key for the distributor.

49. The system of claim 42, wherein:
the service center is further adapted to generate a public reference for the end-user responsive to the data shared with the end-user; and
the service center generates the key for the end-user responsive to the public reference.

50. The system of claim 49, wherein:
the content owner is adapted to provide the key for the content to the service center; and
the service center is adapted to provide the key for the content and the public reference for the end-user to the distributor.

51. The system of claim 42, wherein:
the content owner is further adapted to generate a public reference for the distributor responsive to the data shared with the distributor;
the content owner generates the key for the distributor responsive to the public reference; and
the distributor is further adapted to remove the second level of encryption from the key for the content responsive to the public reference.

52. The system of claim 42, wherein:
the end-user is adapted to remove the first level of encryption from the key for the content and utilize the key for the content to access the encrypted content.

53. The system of claim 42, wherein:
the service center is further adapted to generate a public reference for the end-user responsive to the data shared with the end-user; and
the service center generates the key for the end-user responsive to the public reference.

54. The system of claim 53, wherein:
the content owner is adapted to provide the key for the content to the service center; and
the service center is adapted to provide the key for the content and the public reference for the end-user to the distributor.

55. The system of claim 54, wherein:
the distributor is further adapted to provide the key for the content and the public reference for the end-user to the end user; and
the end-user is further adapted to remove the first level of encryption from the key for the content responsive to the public reference for the end-user.

56. The system of claim 42, wherein:
the end-user comprises a user access system for interacting with the distributor and/or service center.

57. The system of claim 42, wherein:
the distributor comprises a provider access system for interacting with the end-user.

58. They system of claim 42, wherein:
the service center comprises a provider access system for interacting with the distributor and/or end-user.

59. The system of claim 42, wherein:
the content owner comprises a provider access system for interacting with the service center and/or distributor.

60. A computer program product comprising:
a computer-readable medium having computer program code embodied therein for controlling access to encrypted content, the computer program code comprising:
a module for receiving an identification of the encrypted content;
a module for generating, responsive to the identification of the encrypted content, a response including a decryption key for the content, the response encrypted with a plurality of levels of encryption; and
a module for providing the response to a distributor system;
wherein:
the distributor system is adapted to remove a level of encryption from the response to produce a partially-decrypted response and provide the partially-decrypted response to an end-user system; and
the end-user system is adapted to decrypt the partially-decrypted response and access the decryption key for the encrypted content.

61. The computer program product of claim 60, wherein the module for receiving an identification of the encrypted content comprises:
a module for receiving an identification of the end-user system, wherein a level of encryption of the response can be decrypted by only the identified end-user system.

62. The computer program product of claim 60, further comprising:
a module receiving a key associated with the end-user system, wherein a level of encryption of the response is generated responsive to the key associated with the end-user system.

63. The computer program product of claim 60, further comprising:
a module for establishing shared data between a service center system and the end-user system, wherein the key associated with the end-user system is generated responsive to the shared data.

64. The computer program product of claim 63, wherein the key associated with the end-user system comprises a symmetric encryption/decryption key.

65. The computer program product of claim 63, wherein the key associated with the end-user system comprises an asymmetric encryption key.

66. The computer program product of claim 63, wherein the key associated with the end-user system is generated responsive to the shared data and a public reference.

67. The computer program product of claim 66, wherein the key is a symmetric encryption/decryption key.

68. The computer program product of claim 60, wherein the module for receiving an identification of the encrypted content comprises:
a module for receiving an identification of a distributor system, wherein a level of encryption of the response can be decrypted by only the identified distributor system.

69. The computer program product of claim 60, further comprising:
a module for establishing shared secret data with the distributor system.

70. The computer program product of claim 69, wherein the shared data comprises a symmetric encryption/decryption key.

71. The computer program product of claim 69, wherein the shared data comprises asymmetric encryption/decryption keys.

72. The computer program product of claim 69, wherein the distributor system is adapted to generate a key for decrypting a level of encryption responsive to the shared data and a public reference.

73. The computer program product of claim 69, wherein the module for generating comprises:
a module for generating a level of encryption of the response responsive to the data shared with the distributor system.

74. The computer program product of claim 69, wherein the distributor system is adapted to utilize the shared data to remove the level of encryption from the response.

75. A system for controlling access to encrypted content, comprising:
means for distributing encrypted content to a distributor, the content identified by a content identification (ID) and the distributor identified by a distributor ID;
means for receiving the content ID, the distributor ID, and an end-user ID identifying an end-user seeking access to the content from the distributor identified by the distributor ID;
means for identifying a key for the content identified by the content ID;
means for encrypting the key for the content, wherein the key for the content can be decrypted by only the end-user identified by the end-user ID; and
means for providing the encrypted key for the content to the end-user identified by the end-user ID.

76. The system of claim 75, wherein:
the means for receiving comprises:
means for generating an encryption key responsive to the end-user ID; and
the means for encrypting the key for the content comprises:
means for encrypting the key for the content taking into account the encryption key generated responsive to the end-user ID.

77. The system of claim 76, further comprising:
means for establishing shared secret data with the end-user identified by the end-user ID;
wherein the means for generating the encryption key responsive to the end-user ID generates the encryption key responsive to the data shared with the identified end-user.

78. The system of claim 77, wherein the encryption key comprises a symmetric encryption/decryption key.

79. The system of claim 77, wherein the encryption key comprises asymmetric encryption key.

80. The system of claim 77, wherein the end-user is adapted to use the shared data and a public reference to generate a key for decrypting the key for the content.

81. The system of claim 76, further comprising:
means for generating a public reference responsive to the end-user ID;
wherein the identified end-user utilizes the public reference and the encryption key generated responsive to the end-user ID to decrypt the encrypted key for the content.

82. The system of claim 75, wherein:
the means for providing comprises:
means for attaching a public reference associated with the identified end-user to the encrypted key; and
the identified end-user utilizes the public reference to decrypt the encrypted key for the content.

83. The system of claim 75, wherein the means for encrypting the key for the content comprises:
means for encrypting the key for the content with multiple levels of encryption;
wherein a first level of encryption can be decrypted by only the distributor identified by the distributor ID and a second level of encryption can be decrypted by only the end-user identified by the end-user ID.

84. The system of claim 83, wherein:
the means for providing comprises:
means for providing the encrypted key for the content to the distributor identified by the distributor ID; and
the distributor decrypts the first level of encryption from the key for the content and provides the key for the content encrypted with the second level of encryption to the end-user.

85. The system of claim 83, wherein:
shared data is established with the distributor identified by the distributor ID; and
the means for encrypting the key with multiple levels of encryption comprises:
means for generating a key for the distributor and a public reference for the distributor responsive to the shared data;
means for generating the first level of encryption responsive to the key for the distributor and the public reference for the distributor; and
means for attaching the public reference for the distributor to the encrypted key for the content.

86. The system of claim 75, wherein:
shared data is established with the end-user identified by the end-user ID and wherein the step of encrypting the key for the content comprises:
means for generating a key for the end-user and a public reference for the end-user responsive to the shared data;
means for encrypting the key for the content responsive to the key for the end-user and the public reference for the end-user; and
means for attaching the public reference for the end-user to the encrypted key for the content; and
the identified end-user can utilize the shared data and the public reference to decrypt the encrypted key for the content.

87. A method for securing content for distribution in a hopscotch ticketing system, comprising the steps of:
generating a content key for the content;
generating reference data for the content;
generating an encryption key for the content responsive to the content key and the reference data; and
encrypting at least some of the content with the encryption key for the content.

88. The method of claim 87, wherein the step of generating an encryption key for the content comprises the substep of:
generating a plurality of encryption keys;
wherein the encrypting step encrypts different portions of the content with different ones of the plurality of encryption keys.

89. The method of claim 87, wherein the reference data is publicly accessible.

90. The method of claim 87, wherein the reference data is encoded in plaintext with the encrypted content.

91. The method of claim 87, wherein the encrypted content is approximately the same size as the unencrypted content.
